(19) United States
(12) Patent Application Publication
(10) Pub. No.: US 2011/0157473 A1
(43) Pub. Date: Jun. 30, 2011

(54) METHOD, APPARATUS, AND SYSTEM FOR SIMULTANEOUSLY PREVIEWING CONTENTS FROM MULTIPLE PROTECTED SOURCES

(76) Inventors: Hoon Choi, Mountain View, CA (US); Daekyeung Kim, Palo Alto, CA (US); Wooseung Yang, Santa Clara, CA (US); Young Il Kim, Santa Clara, CA (US); Jeoong Sung Park, Cupertino, CA (US)

(21) Appl. No.: 12/650,357

(22) Filed: Dec. 30, 2009

(51) Int. Cl. H04N 5/45

(52) U.S. Cl. 348/566; 348/565; 348/E05.104

(57) ABSTRACT

A method, apparatus and system for simultaneously previewing contents from multiple protected sources. A primary data stream associated with a primary port is generated, the primary data stream having a primary image to be displayed on a display screen. A secondary data stream is generated associated with a plurality of secondary ports coupled with the primary port, the secondary data stream having a plurality of secondary images received from the plurality of secondary ports. The secondary data stream and the primary data stream are merged into a display data stream, the display data stream having the primary image and further having the plurality of secondary images as a plurality of preview images. The primary image and the plurality of preview images are displayed on the display screen, wherein each of the plurality of preview images is displayed through an inset screen on the display screen.

### FIELD

Embodiments of the invention generally relate to the field of electronic networks and, more particularly, to simultaneously previewing contents from multiple protected sources.

### BACKGROUND

In the operation of a system that utilizes multiple data streams, such as multiple media data streams for display. The data may include data protected by High-bandwidth Digital Content Protection (HDCP) data, which is referred to herein as HDCP data. Communicating multiple media data streams may include a flow of content between a transmitting authority (e.g., cable television (TV) or satellite companies) and a receiving device (e.g., a TV) via a transmission device (e.g., cable/satellite signal transmission device) through a High-Definition Multimedia Interface (HDMI).

Certain receiving devices (e.g., televisions) employ the conventional technology of fully displaying one program while displaying another program in an inset window. However, this conventional technology has been mainly used only for legacy analog inputs because of their low resolutions and lower demand for hardware resources. Though recently, some conventional techniques have begin to cover digital inputs; nevertheless, they are still based on a conventional single feed system that broadcasts a single feed, while a relevant transmitting authority puts multiple contents into a single image and sends it through a single feed. In other words, the generation of image having inset windows is done in transmitting authority which is far away from the user-side and thus, controlling the user-side receiving device.

### SUMMARY

A method, apparatus, and system for simultaneously previewing contents from multiple protected sources is disclosed.

In one embodiment, a method includes generating a primary data stream associated with a primary port, the primary data stream having a primary image to be displayed on a display screen, generating a secondary data stream associated with a plurality of secondary ports coupled with the primary port, the secondary data stream having a plurality of secondary images received from the plurality of secondary ports, merging the secondary data stream with the primary data stream into a display data stream, the display data stream having the primary image and further having the plurality of secondary images as a plurality of preview images, and displaying the primary image and the plurality of preview images on the display screen, wherein each of the plurality of preview images is displayed through an inset screen on the display screen.

In one embodiment, a system includes a data processing device having a storage medium and a processor coupled with the storage medium, the processor to generate a primary data stream associated with a primary port, the primary data stream having a primary image to be displayed on a display screen, generate a secondary data stream associated with a plurality of secondary ports coupled with the primary port, the secondary data stream having a plurality of secondary images received from the plurality of secondary ports, merge the secondary data stream with the primary data stream into a display data stream, the display data stream having the primary image and further having the plurality of secondary images as a plurality of preview images. The apparatus further includes a display device coupled with the data processing device, the display device to display the primary image and the plurality of preview images on the display screen, wherein each of the plurality of preview images is displayed through an inset screen on the display screen.

In one embodiment, an apparatus includes a data processing device having a storage medium and a processor coupled with the storage medium, the processor to generate a primary data stream associated with a primary port, the primary data stream having a primary image to be displayed on a display screen, generate a secondary data stream associated with a plurality of secondary ports coupled with the primary port, the secondary data stream having a plurality of secondary images received from the plurality of secondary ports, and merge the secondary data stream with the primary data stream into a display data stream, the display data stream having the primary image and further having the plurality of secondary images as a plurality of preview images.

### BRIEF DESCRIPTION OF THE DRAWINGS

Embodiments of the invention are illustrated by way of example, and not by way of limitation, in the figures of the accompanying drawings in which like reference numerals refer to similar elements:

FIG. 1 illustrates a logical block diagram of an HDCP pre-authentication system;

FIG. 2 illustrates an embodiment of an HDCP engine-to-port system employing a one-on-one ratio between the HDCP engines and the corresponding ports;

FIG. 3 illustrates an embodiment of a technique for displaying multiple data streams from multiple sources;

FIG. 4A illustrates an embodiment of a preview system;

FIG. 4B illustrates an embodiment of a stream mixer;

FIG. 5 illustrates an embodiment of a process for displaying multiple data streams from multiple sources; and

FIG. 6 is an illustration of embodiments of components of a network computer device employing an embodiment of the present invention.

### DETAILED DESCRIPTION

Embodiments of the invention are generally directed to previewing contents from multiple protected sources. In one embodiment, a receiving device (e.g., TV) displays multiple contents (e.g., video images with audio) being received from multiple feeds via multiple protected sources or ports (e.g., HDMI or non-HDMI input ports). One of the multiple images being displayed serves as the primary image (being received via a main HDMI or non-HDMI port) encompassing most of the display screen, while other images are displayed as secondary images (being received via corresponding roving HDMI or non-HDMI ports) occupying small sections or insets of the display screen. Further details are discussed throughout this document. It is contemplated that a port may include an HDMI or a non-HDMI port and that HDMI ports are used in this document merely an example and brevity and clarity.

As used herein, “network” or “communication network” mean an interconnection network to deliver digital media content (including music, audio/video, gaming, photos, and others) between devices using any number of technologies, such as Serial Advanced Technology Attachment (SATA), Frame Information Structure (FIS), etc. An entertainment network may include a personal entertainment network, such as a network in a household, a network in a business setting, or any other network of devices and/or components. A network includes a Local Area Network (LAN), Wide Area Network (WAN), Metropolitan Area Network (MAN), intranet, the Internet, etc. In a network, certain network devices may be a source of media content, such as a digital television tuner, cable set-top box, handheld device (e.g., personal device assistant (PDA)), video storage server, and other source device. Other devices may display or use media content, such as a digital television, home theater system, audio system, gaming system, and other devices. Further, certain devices may be intended to store or transfer media content, such as video and audio storage servers. Certain devices may perform multiple media functions, such as cable set-top box can serve as a receiver device (receiving information from a cable headed) as well as a transmitter device (transmitting information to a TV) and vice versa. Network devices may be co-located on a single local area network or span over multiple network segments, such as through tunneling between local area networks. A network may also include multiple data encoding and encryption processes as well as identify verification processes, such as unique signature verification and unique identification (ID) comparison.

In content transmission-reception schemes, various tools (e.g., revocation lists) are used to detect, verify, and authenticate devices that communicate with each other. These devices include media devices, such a digital versatile disk or digital video disk (DVD) players, compact disk (CD) players, TVs, computers, etc. For example, a transmitting device (e.g., a DVD player) can use such tools to authenticate a receiving device (e.g., TV) to determine whether the receiving device is legal or eligible to receive premium protected media content from the transmitting device. Similarly, the receiving device authenticates the transmitting device prior to accepting the protected media content from it. To avoid waiting time of such authentication processes, pre-authentication of devices is performed.

“Pre-Authentication” is a term used here to indicate a feature of devices, including HDMI switch products, to allow them to switch more quickly between inputs. The term describes the performing of necessary HDCP authentication before switching to the input, instead of after switching. In this way, the significant delays associated with authentication may be hidden in the background of operation, instead of the foreground.

Since HDCP receivers are considered slave devices, an HDCP receiver is not expected to explicitly signal a transmitter with any request or status. Even a “broken” link is typically signaled implicitly (and rather crudely) by intentionally “breaking” the Ri sequence (the response from receiver (Rx) to transmitter (Tx) when Tx checks if the link is kept being synchronized securely). There are a wide variety of HDCP transmitters. Many of these may exhibit unique and quirky behaviors. Much of the delay that pre-authentication addresses is caused by these transmitter quirks, and not by the receiver. While, ideally, the transmitters would be modified to avoid these performance issues, realistically, this cannot be expected, and thus pre-authentication can provide significant value in data stream operations.

With regard to HDCP synchronization; in general, an HDCP receiver needs two things to stay synchronized with the transmitter: (1) the receiver knows where the frame boundaries are; and (2) the receiver knows which of these frames contains a signal that indicates that a frame is encrypted (e.g., CTL3). “CTL3” is used as an example of encryption indicator without any limitation for the ease of explanation, brevity, and clarity.

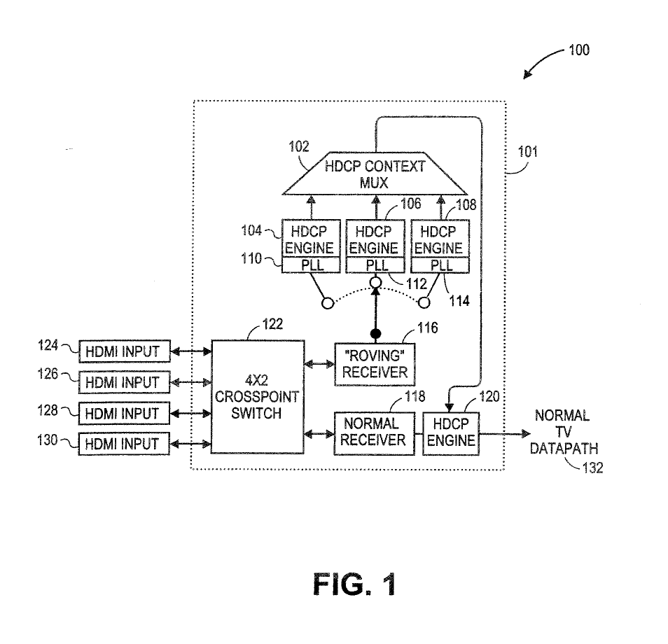

FIG. 1 illustrates an embodiment of an HDCP pre-authentication system 100. The illustrated HDCP pre-authentication system 100 includes an HDCP (pre-authenticated) device 101 that include a dedicated HDCP engine block 104-108, 120 per input port. In general, the normal HDCP logic is used in every case, even when the open-loop ciphers do not do any decryption. This is because the re-keying functions use the HDCP logic to maximize dispersion. Further, an open-loop HDCP engine 104-108 uses a Phase Lock Loop (PLL) 110-114 or PLL-like circuit to lock onto the frame rate and provide ongoing information about where the frame boundaries are while running in the open-loop mode.

A single special purpose Transition Minimalized Differential Signaling (TMDS) receiver 116 (e.g., roving receiver) may be used to sequentially provide the essential information to the open-loop logic. This roving receiver 116 cycles through the currently unused inputs, finds the frame boundaries (so that the corresponding PLL 110-114 can lock on), and also finds the first CTL3 signal when an authentication occurs. In some cases, this could be a stripped-down version of a TMDS receiver 116 because in essence, it merely needs the VSYNC and CTL3 indicators.

Further, a main/normal TV data path 132 may work in the same manner as conventional switch products. In operation, one of the input ports can be selected for the main/normal data path 132, while the data stream is decoded and decrypted (e.g., decipher to take out original audio/video (A/V) data from the incoming encrypted data) as necessary, and then is routed through the remainder of the appliance.

The roving receiver 116 samples the currently idle ports (i.e., all ports except the one selected by user to watch), one at a time. This necessitates a state-machine or (more likely) a microcontroller of some kind to control the process. The initial operational sequence typically follows: (1) the roving receiver 116 is connected to an unused input port (i.e., the port that is not selected by the user to watch) and monitors it for video; (2) the HDCP engine 104-108 is connected to the port as well, which means that the I²C bus is connected (e.g., I²C is regarded as an additional communication channel between Tx and Rx for link synchronization check). It may also mean signaling hotplug, to indicate to the source that it is ready for getting transmission and the HDCP authentication. This may also facilitate the transfer of Extended Display Identification Data (EDID) information, but this is beyond the scope of this disclosure; (3) when video is stable, the roving receiver 116 provides information to align the PLL with the frame boundaries; (4) the state machine or microcontroller waits a time period for the HDCP authentication to begin. If it does, it continues to wait until the authentication completes and the first CTL3 signal is received; (5) the HDCP block continues to cycle in an open-loop function counting “frames” using information only from the PLL. The I²C port stays connected, and the hotplug signal continues to indicate that a receiver is connected; (6) the roving receiver 116 then continues on to the next port and performs the same operations. In some embodiments, once the roving receiver 116 has started all ports, it then goes into a service loop, checking each port in sequence.

The illustrated system 100 may contain m ports to select each port 124-130 one by one in the background through a Time Division Multiplexing (TDM) technique. HDMI signals from the selected port 124-130 are used for pre-authentication. Each roving port 124-128 having its own HDCP Engine 104-108 is synchronized with the main port 130 such that each roving port 124-128 is ready for a change to be selected to replace the main port 130. In this way, the roving pipe gets HDMI signals from all background ports 124-128 one by one and keeps them pre-authenticated and ready.

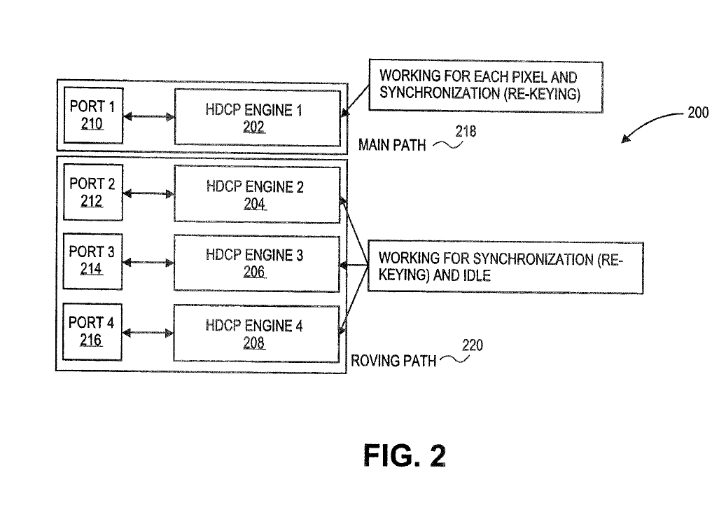

FIG. 2 illustrates an embodiment of an HDCP engine-to-port system 200 employing a one-on-one ratio between the HDCP engines 202-208 and the corresponding ports 210-216. The illustrated system 200 includes four HDCP engines 202-208 that corresponding to ports 210-216 in a one-on-one ratio, e.g., each HDCP engine 202-208 corresponds to a single port 210-216. The system 200 further illustrates port 1 210 as being in main pipe or path 218 and is associated with HDCP engine 1 202. Other paths 2-3 204-206 are in roving pipe or path 220 and are associated with HDCP engines 2-4 204-208. It is to be noted that the terms pipe and path are used interchangeably throughout this document. HDCP engine 202 of main path 218 works for each pixel (to decrypt and get the video and audio data) and synchronization (e.g., re-keying, which refers to at every frame boundary, Tx and Rx change the shared key used for cipher and decipher the contents. This is to prevent a key from being used for too many data. For example, at the 128^{th} frame, Tx and Rx exchange the residue of the key and check the synchronization of the link, called Ri checking in HDCP), while HDCP engines 204-208 of roving path 220 work for synchronization (e.g., re-keying) and idle.

HDCP engines 204-208 of roving path 220 work for a short period of time (e.g., performing the re-keying process) merely to synchronize Ri values that are used to make a transmitter (Tx) trust a receiver (Rx) is synchronized. In other words, HDCP engines 204-208 are only needed and are functioning during the synchronization period and the rest of the time period they become idle without any further use for the remainder of the time period while HDCP engine 202 continues to work.

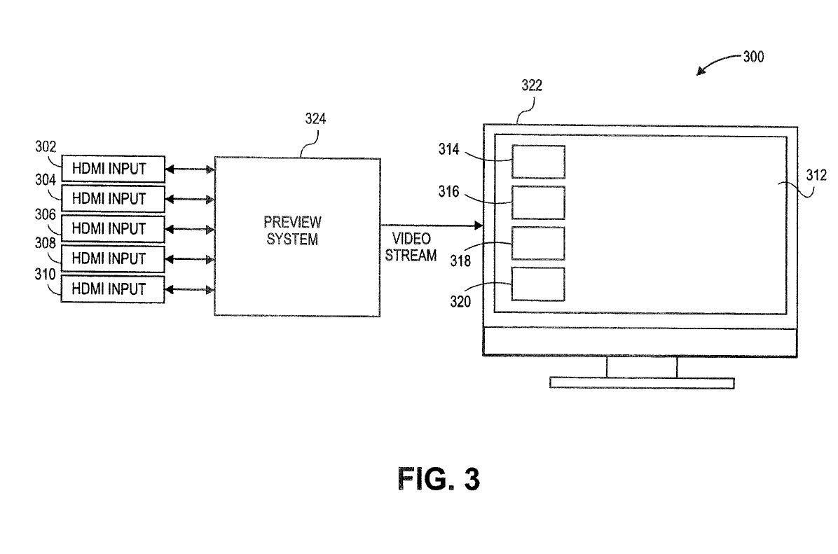

FIG. 3 illustrates an embodiment of a technique for displaying multiple data streams 312-320 from multiple sources 302-310. In one embodiment, preview system 324 employs the pre-authentication and roving techniques of FIGS. 1-2 to display multiple data streams 312-320 on a receiving device (e.g., television) 322. Each data stream (e.g., video data/content/program) being displayed through multiple screens is received from a separate HDMI input source/port 302-310. In one embodiment, data streams 312-320, having the pre-authentication and roving functionalities, include not only main data from the main HDMI port (assuming that HMDI input port 302 serves as the corresponding main port) but also roving data extracted from one or more roving HDMI ports (assuming that HDMI input ports 304-310 serve as the corresponding roving ports) that is then downsized as roving snapshots. These roving snapshots from the roving ports 304-310 are then merged with the main data image from the main port 302 such that the viewers see the main port-based data stream 312 as a full main image on the video display screen of the receiving device 322 and the roving ports-based data streams 314-320 as the roving snapshots through a corresponding number of inset video display screens, as illustrated here.

Using the described pre-authentication technique, pre-authentication of all ports, i.e., including the main HDMI port 302 as well as the roving HDMI ports 304-310, is performed. For example, pre-authentication of the roving ports 304-310 may be performed in the background such that each roving port 304-310 remains authenticated and available whenever it is needed to serve as the main port (to replace the currently serving main port 302) and while the data/content is being extracted from all ports 302-310.

Due to the difference of resolution of the roving ports-based data streams (roving data streams/images) 314-320 and their corresponding clocks, SYNCs, etc., each sub-image of each roving data stream 314-320 coming from a roving port 304-310 is stored into a frame buffer. On the other hand, the image of the main port-based data stream (main data stream/image) 312 may not be put into a frame buffer due to its relatively large size (e.g., about 6 MB for 1080 p/24 bpp); instead, the main image pixels are placed with those of the roving sub-images (e.g., snapshots as previously described) on the fly that do not use a frame buffer for the main image. In one embodiment, a roving sub-image 314-320 is converted such that it is in compliance with the main image 312 and put into the main image 312 at a correct position; this way, a user can see all video frames including the main image 312 and the roving sub-images 314-320 from the main port 302 and the roving ports 304-310, respectively, in one screen (including screen insets) as illustrated here.

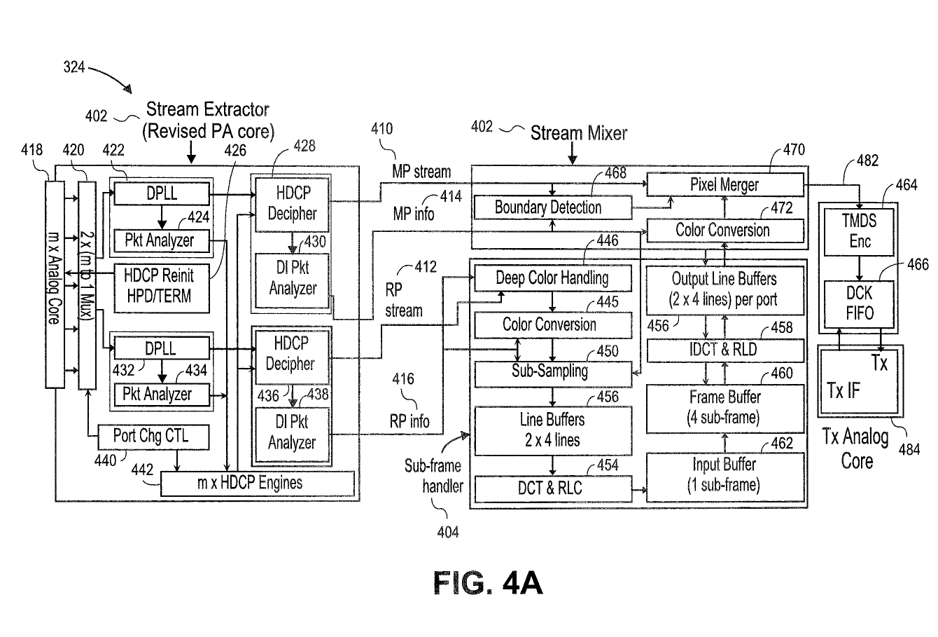

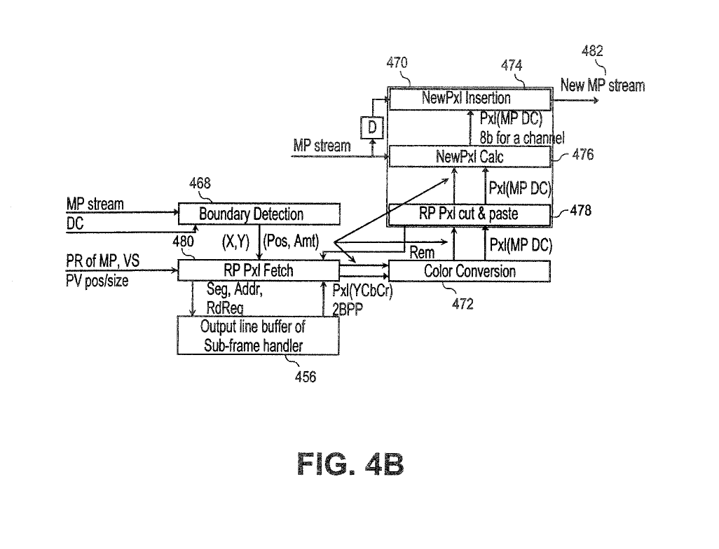

FIG. 4A illustrates an embodiment of a preview system 324. The illustrated preview system 324 includes four major parts including: a stream extractor 402, a sub-frame handler 404, a stream mixer 406, and a Tx interface 408. The stream extractor 402 receives multiple HDMI inputs (such as HDMI ports 302-310 of FIG. 3) which are then generated into two data streams: a main port (MP) data stream 410 relating to a main port (e.g., main HDMI port 302) and a number of roving port (RP) data streams 412 relating to a corresponding number of roving ports (e.g., roving HDMI ports 304-310). The MP data stream 410 is used to provide the MP image on a display screen associated with a receiver device and this MP image further contains previews of the sub-images (e.g., snapshots) extracted from the roving data streams being extracted from the corresponding roving ports. The MP data stream 410 also contains audio and other control/information packets associated with the main image and the sub-images.

As illustrated, any relevant MP information 414 is also generated and associated with the MP data stream 410. RP data stream 412 generates multiple streams having snapshots of the roving images being received from the roving ports in time-multiplexing, while simultaneously keeping the roving HDCP ports pre-authenticated in the background. Any control/information packets of the RP data stream 412 may be used, but not forwarded to the downstream to TV. As with the MP data stream 410 and its corresponding MP information stream 414, a relevant RP information stream 416 is also generated and associated with the RP data stream 412. These MP and RP information streams 414, 416 may include relevant video information (e.g., color depth, resolution, etc.) as well as audio information relating to the MP, RP data streams 410, 412. The main pipe (associated with the main port) and the roving pipe (associated with the roving ports) includes HDCP decipher 428 and 436 and control/information packet (e.g., Data Island (DI) Packet) Analyzer 430 and 438 to generate an audio/video (AV) data stream and its relevant information stream (such as resolution, color depth (e.g., how many bits are used to represent a color), etc.) and also to detect a possible bad HDCP situation and reinitiate HDCP authentication 426 or pre-authentication in the background as needed.

As illustrated, both the MP and RP-related HDCP deciphers 428, 436 and the DI packet analyzers 430, 438 are coupled to their corresponding DPLLs 422, 432 and the packet analyzers 424, 434 for processing and generating their respective output data streams 410, 412 and their associated information streams 414, 416. The stream extractor 402 further includes an analog core 418 and a multiplexer 420 a well as an HDCP re-initiator 426, a port change control component 440, and an m HDCP engines 442 to support authentication of m ports. Any HDMI signals from each selected port are then used for pre-authentication. The illustrated components of the stream extractor 402 and their functionalities have been further described in FIG. 1.

The MP streams 410, 414, after leaving the stream extractor 402, enter the stream mixer 406, while the RP streams 412, 416 enter the sub-frame handler 404. The sub-frame handler 404 captures the image of back ground roving port through the RP streams 412, 416. The RP streams 412, 416 are received at a deep color handling component 446 which extracts pixels per color depth information from the RP streams 412, 416. Once the extraction of pixels is performed, color conversion of the pixels is performed using a color conversion component 448 followed by performing down sampling per each resolution via a sub-sampling/down-scaling logic 450 and then, compression is performed (using a Discrete Cosine Transform (DCT)/Run Length Coding (RLC) logic 454) and the result is then stored in a frame memory in an input buffer 462. For each frame of the MP image, the compressed image is taken out from a frame buffer 460 and then, it is decompressed and put it into an output buffer 456 via Inverse Discrete Cosine Transform (IDCT) and Run Length Decoding (RLD) and is provided to the stream mixer 406 at a proper time. Sub-image is updated each time the roving pipe comes back to the port, and the same image is sent again and again until the content is updated.

The deep color handling component 446 detects pixel boundary using color depth information (i.e., how many bits are used for representing each color in a pixel) of an RP via the RP information stream 416, and extracts its pixels with a valid signal. The extracted pixels go through color conversion via the color conversion component 448.

The logic 450 performs sub-sampling/down-scaling (i.e., reducing the picture size). A sub-sampling/down-scaling ratio is determined by the resolution, video format (such as interlacing), and pixel replication of the main port and those of the roving ports. When each port has a different size of the video source, its downsizing ratio can also be different. For example, the number of pixels for a 1080 p image is bigger than that for a 480 p image to preserve the same size of inset displays (called PVs, PreViews) regardless of the main image resolution. The sub-sampled/down-scaled pixels are put into one of the line buffers 452, while the contents of the other line buffers 452 are used by the following block (e.g., dual buffering). Each line buffer 452 may contain several lines (e.g., 4 lines) of pixels for the following operation (e.g., 4×4 DCT). DCT and RLC (Run Length Coding) at a DCT/RLC logic 454 get pixel data (e.g., 4×4 pixel data) from one of the line buffers 452 which is not under getting new data and do compression. The output coefficients which are the result from RLC of DCT at the DCT/RLC logic 454 are put into the input buffer 462.

The contents of the input buffer 462 (e.g., one frame) are copied to one of several (e.g., four) segments of the frame buffer 460 that is assigned to the current RP. This copying is performed during a Vertical Sync (VS) period of the main image to prevent any tearing effect and if the sampling of RP data is done successfully. An IDCT/RLD (Run Length Decoding) logic 458 monitors the “empty” status of the output line buffers 456 and if they become empty, the IDCT/RLD logic 458 gets one block of coefficients from the frame buffer 460 and performs decompression. The output of this decompression (e.g., YCbCr in 4×4 block) goes into one of the output line buffers 456 that is empty. This output line buffer 456 then sends out one pixel data per each request from the stream mixer 406. The assignment of any segments of the frame buffer 460 and the output line buffer 456 to each port can change dynamically per the MP selection to support m−1 PVs (e.g., PreViews, inset displays) among m ports with merely m−1 segments.

Referring now to FIG. 4B, the stream mixer 406 receives the MP data and information streams 410, 414. Once the MP data stream 410, along with its associated MP information stream 414, is received, its pixel boundary is detected by boundary detection logic 468. The boundary detection logic 468 then receives pixels from the output buffer 456 of the sub-frame handler 404, which is then followed by performing the color conversion per main color using the color conversion component 472, and further followed by mixing or replacing of the pixels of the MP data stream 410 with the color-converted pixels of any sub-images on the fly. In one embodiment, using this novel technique of mixing or replacing of MP pixel with that of the RP, images with inset displays are generated without using a frame buffer for the MP data stream 410.

The boundary detection logic 468 detects pixel boundary using any deep color (e.g., color depth representing the number of bits per color in a pixel) information obtained from the MP information stream 414 and generates pixel coordination (e.g., X, Y) and any relevant pixel boundary information (e.g., Pos, Amt). A RP pixel fetch block 480 evaluates and determines whether one pixel from an RP image is needed and if it is needed, it sends out a pixel data read request to the output line buffer 456. For example, it considers if current pixel coordination (X, Y) is in any of PV (inset display) area (which means whether pixel data from RP is needed) and if there is enough remaining pixel data of RP that is previously read out and not yet used (if not, a new pixel of RP is needed). The pixel data from output line buffers 456 is, for example, 2 bytes for one pixel (e.g., YCbCr422) and it goes into the color conversion component 472 and becomes the color of the MP image. The output of the color conversion component 472 enters the RP pixel cut & paste block 478 which then extracts the needed amount of bits from the input which then enters into a new pixel calculation block 476 and then merged with the pixel obtained from the MP information stream 414 and then becomes the merged final pixel. The final pixel replaces the pixel provided by the MP information stream 414 in a new pixel insertion block 474. The new pixel insertion block 474 generates and provides a new MP stream 482. In these processes, any sub-images are converted to be compliant with the main image and put into the main image at its appropriate position. For example, color depth, different color spaces (such as YCbCr vs. RGB), pixel repetition, interleaving vs. progressive, different resolutions and video formats of both the main image and the roving images are considered.

Referring back to FIG. 4A, the new MP stream 482 serves as the output that passes through the Tx interface 408 which provides TMDS encoding of the stream using a TMDS encoder 464, while a First-In-First-Out (FIFO) block 466 places the MP stream 482 in FIFO for an interface with Tx analog block. The new MP stream 482 may then be sent to a TX analog core 484. The MP stream 482 contains the main image as well as the roving sub-images and these images (having video and/or audio) are displayed by the display/final receiving device (e.g., TV) such that the main device occupies most of the screen while the roving sub-images are shown in small inset screens.

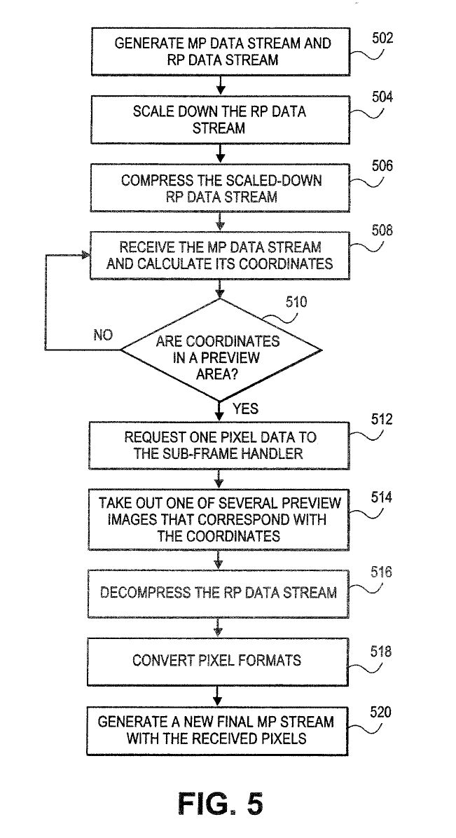

FIG. 5 illustrates an embodiment of a process for displaying multiple data streams from multiple sources. In one embodiment, a stream extractor is coupled with a number of input ports (e.g., including HDMI main port and one or more HDMI roving ports). The stream extractor is used to generate two data streams: an MP data stream (MP_STRM) relating to the main port and a RP data stream (RP_STRM) relating to a roving port at processing block 502. The stream extractor repeatedly performs this function for each one of a number of roving ports one roving port at a time. At processing block 504, a sub-frame handler, in communication with the stream extractor, scales down the RP data stream associated with a roving port. At processing block 506, the sub-frame handler performs compression of the scaled roving port data stream and then stores it in an internal buffer.

At processing block 508, a stream mixer, in communication with the stream extractor, receives the MP data stream and calculates its coefficients coordinates (e.g., X, Y). At decision block 510, the stream mixer compares the (X, Y) coordinates with the area of preview images provided by users to determine whether the (X, Y) coordinates are in that preview image area. If the (X, Y) coordinates are in the preview image area, the stream mixer requests one pixel data to the sub-frame handler at processing block 512. If not, the process continues with processing block 508. If the sub-frame handler gets a request from the stream mixer, it takes out one of several preview images that corresponds with the current (X, Y) coordinates from its internal buffer at processing block 514.

At processing block 516, the sub-frame handler further decompresses the RP data stream that was previously compressed and sends a pixel to the stream mixer per its request. At processing block 518, the stream mixer is then used to convert pixel formats (e.g., color conversion using its color conversion logic) of the pixel received from the sub-frame handler in accordance with those of the MP data stream. At processing block 520, the stream mixer puts the received pixel into the MP data stream (e.g., replacing the pixel of the MP data stream with that of the preview images using its pixel merger).

A previously disclosed, HDMI ports are merely described as an example and brevity and clarity and that it is contemplated that other non-HDMI ports may also be used and employed. For example, video sources such as old legacy analog inputs are converted into RGB and control streams in TV for internal processing that can be easily converted to and included into an HDMI stream. Therefore, they can be handled in the same way as preview operation as mentioned throughout this document. Furthermore, the compression and storing mechanism described in this document is used as an example and provided for brevity and clarity. It is contemplated that various other compression/decompression and storing schemes can be used in the framework according to one or more embodiments of the present invention.

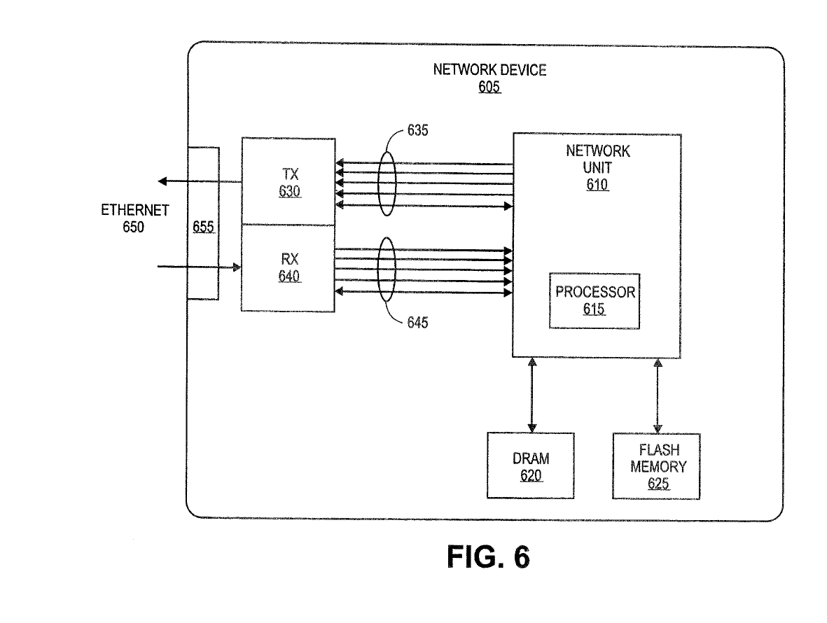

FIG. 6 is an illustration of embodiments of components of a network computer device 605 employing an embodiment of the present invention. In this illustration, a network device 605 may be any device in a network, including, but not limited to, a television, a cable set-top box, a radio, a DVD player, a CD player, a smart phone, a storage unit, a game console, or other media device. In some embodiments, the network device 605 includes a network unit 610 to provide network functions. The network functions include, but are not limited to, the generation, transfer, storage, and reception of media content streams. The network unit 610 may be implemented as a single system on a chip (SoC) or as multiple components.

In some embodiments, the network unit 610 includes a processor for the processing of data. The processing of data may include the generation of media data streams, the manipulation of media data streams in transfer or storage, and the decrypting and decoding of media data streams for usage. The network device may also include memory to support network operations, such as DRAM (dynamic random access memory) 620 or other similar memory and flash memory 625 or other nonvolatile memory.

The network device 605 may also include a transmitter 630 and/or a receiver 640 for transmission of data on the network or the reception of data from the network, respectively, via one or more network interfaces 655. The transmitter 630 or receiver 640 may be connected to a wired transmission cable, including, for example, an Ethernet cable 650, a coaxial cable, or to a wireless unit. The transmitter 630 or receiver 640 may be coupled with one or more lines, such as lines 635 for data transmission and lines 645 for data reception, to the network unit 610 for data transfer and control signals. Additional connections may also be present. The network device 605 also may include numerous components for media operation of the device, which are not illustrated here.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described.

Various embodiments of the present invention may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

One or more modules, components, or elements described throughout this document, such as the ones shown within or associated with an embodiment of a port multiplier enhancement mechanism may include hardware, software, and/or a combination thereof. In a case where a module includes software, the software data, instructions, and/or configuration may be provided via an article of manufacture by a machine/electronic device/hardware. An article of manufacture may include a machine accessible/readable medium having content to provide instructions, data, etc. The content may result in an electronic device, for example, a filer, a disk, or a disk controller as described herein, performing various operations or executions described.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), electrically EPROM (EEPROM), magnet or optical cards, flash memory, or other type of media/machine-readable medium suitable for storing electronic instructions. Moreover, the present invention may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
generating a primary data stream associated with a primary port, the primary data stream having a primary image to be displayed on a display screen;
generating a secondary data stream associated with a plurality of secondary ports coupled with the primary port, the secondary data stream having a plurality of secondary images received from the plurality of secondary ports;
merging the secondary data stream with the primary data stream into a display data stream, the display data stream having the primary image and further having the plurality of secondary images as a plurality of preview images; and
displaying the primary image and the plurality of preview images on the display screen, wherein each of the plurality of preview images is displayed through an inset screen on the display screen.

2. The method of claim 1, wherein the primary port includes a main port, and wherein the plurality of secondary ports includes a plurality of roving ports.

3. The method of claim 2, further comprising pre-authenticating the roving ports in the background while the main port remains the primary port such that each roving port is ready to serve.

4. The method of claim 1, further comprising processing the secondary data stream, wherein processing includes extracting pixels per color depth, performing color conversion and down-sampling/down-scaling per resolution, and compressing and storing the secondary data stream.

5. The method of claim 1, further comprising processing the primary data stream, wherein processing includes detecting pixel boundary and detecting pixels.

6. The method of claim 1, further comprising:
receiving secondary pixels of the secondary data stream;
color converting the secondary pixels following a color depth formatting of primary pixels of the primary data stream; and
merging or replacing the primary pixels with the secondary pixels.

7. The method of claim 1, further comprising:
merging the color converted secondary pixels with the primary pixels to generate display pixels;
inserting the plurality of secondary images as sub-images into the display data stream, the display data stream including the display pixels.

8. A system comprising:
a data processing device having a storage medium and a processor coupled with the storage medium, the processor to
generate a primary data stream associated with a primary port, the primary data stream having a primary image to be displayed on a display screen;
generate a secondary data stream associated with a plurality of secondary ports coupled with the primary port, the secondary data stream having a plurality of secondary images received from the plurality of secondary ports;
merge the secondary data stream with the primary data stream into a display data stream, the display data stream having the primary image and further having the plurality of secondary images as a plurality of preview images; and
a display device coupled with the data processing device, the display device to display the primary image and the plurality of preview images on the display screen,
wherein each of the plurality of preview images is displayed through an inset screen on the display screen.

9. The system of claim 8, wherein the primary port includes a main port, and wherein the plurality of secondary ports includes a plurality of roving ports.

10. The system of claim 9, wherein the processor is further to pre-authenticate the roving ports in the background while the main port remains the primary port such that each roving port is ready to serve.

11. The system of claim 8, wherein the processor is further to process the secondary data stream, wherein processing includes extracting pixels per color depth, performing color conversion and down-sampling/down-scaling per resolution, and compressing and storing the secondary data stream.

12. The system of claim 8, wherein the processor is further to process the primary data stream, wherein processing includes detecting pixel boundary and detecting pixels.

13. The system of claim 8, wherein the processor is further to:
receive secondary pixels of the secondary data stream;
color convert the secondary pixels following a color depth formatting of primary pixels of the primary data stream; and
merge or replacing the primary pixels with the secondary pixels.

14. The system of claim 8, wherein the processor is further to:
merge the color converted secondary pixels with the primary pixels to generate display pixels; and
insert the plurality of secondary images as sub-images into the display data stream, the display data stream including the display pixels.

15. An apparatus comprising a data processing device having a storage medium and a processor coupled with the storage medium, the processor to:
generate a primary data stream associated with a primary port, the primary data stream having a primary image to be displayed on a display screen;
generate a secondary data stream associated with a plurality of secondary ports coupled with the primary port, the secondary data stream having a plurality of secondary images received from the plurality of secondary ports; and
merge the secondary data stream with the primary data stream into a display data stream, the display data stream having the primary image and further having the plurality of secondary images as a plurality of preview images.

16. The apparatus of claim 15, further comprising a display device coupled with the data processing device, the display device to: display the primary image and the plurality of preview images on the display screen, wherein each of the plurality of preview images is displayed through an inset screen on the display screen.

17. The apparatus of claim 16, wherein the primary port includes a main port, and wherein the plurality of secondary ports includes a plurality of roving ports.

18. The apparatus of claim 15, wherein the processor is further to pre-authenticate the roving ports in the background while the main port remains the primary port such that each roving port is ready to serve.

19. The apparatus of claim 15, wherein the processor is further to process the secondary data stream, wherein processing includes extracting pixels per color depth, performing color conversion and down-sampling/down-scaling per resolution, and compressing and storing the secondary data stream.

20. The apparatus of claim 15, wherein the processor is further to process the primary data stream, wherein processing includes detecting pixel boundary and detecting pixels.
